(19) United States
(12) Patent Application Publication
(10) Pub. No.: US 2002/0188386 A1
(43) Pub. Date: Dec. 12, 2002

(54) GPS based terrain referenced navigation system

(76) Inventor: Laurence Day, Plymouth (GB)

Correspondence Address: NIXON & VANDERHYE P.C., 8th Floor, 1100 North Glebe Road, Arlington, VA, 22201, US

(21) Appl. No.: 10/139,626

(22) Filed: May 7, 2002

(30) Foreign Application Priority Data
May 9, 2001 (GB) 0111256.4

(51) Int. Cl. G05D 1/00; G01C 21/26

(52) U.S. Cl. 701/4; 701/213

(57) ABSTRACT

The terrain referenced navigation system uses data from a global positioning system (GPS) to determine a vehicles position, velocity and height above ground. The system uses input data from an altimeter device, a digital terrain elevation data, and a GPS position, velocity and time data. The system applies a GPS error process model in addition to a TRN measurement model, to obtain a state vector which includes estimates of current errors in the GPS data. The PVT data input from a GPS receiver is used to determine a current vehicle position and height in geographic axis. Using specifically constructed Kalman filter states, a geographical position and height of the vehicle is reference to the digital terrain elevation data, and an estimated ground clearance at the vehicle position is determined. The ground clearance is differenced with a radar altimeter output, and the residual is processed by Kalman filter to determine a new state vector, including estimates of current errors in the GPS data. The output can be configured to be either referenced to navigation axis, or to the digital terrain database for use by other digital terrain system functions.

### FIELD OF THE INVENTION

The present invention relates to navigation systems, and particularly although not exclusively, to a method and apparatus for providing a terrain referenced navigation system without the use of an inertial navigation system.

### BACKGROUND TO THE INVENTION

Known airborne vehicle navigation systems are based on a wide range of known sensor technology, with a specific navigation system in a particular vehicle making use of the available sensor inputs from that vehicle, and availability of sensors depending upon the age and cost of the vehicle.

Sensors which are most commonly available include:

Air data systems (ADS), producing both air speed and Baro-altitude outputs;

Attitude and heading reference systems (AHRS), outputting vehicle Euler angles;

Radio altimeters (RA), having an output of a height above ground data.

Other sensors which are sometimes available, depending on age and cost of the particular vehicle include inertial navigation systems (INS), global positioning systems (GPS), and a Doppler velocity measuring equipment.

Referring to FIG. 1 herein there is illustrated schematically a vehicle 100 navigating over the earth's surface 101, the vehicle equipped with a radio altimeter (103) for determining a height of the vehicle over the earth's surface, and a global positioning system (GPS) receiver, which receives signals from a satellite 102, and by means of which the vehicle can determine its longitude and latitude position.

A terrain referenced navigation system (TRN) provides accurate navigation by means of referencing a vehicles position with respect to a terrain database. This navigation reference can be used to support other database related functions such as precision ground collision and avoidance systems (PGCAS).

Conventionally, terrain referenced navigation has been achieved using outputs from a radar altimeter, in conjunction with a digital terrain elevation database (DTED) to correct an inertial navigation system (INS) via a Kalman filter as illustrated schematically in FIG. 2 herein. The Kalman filter comprises an inertial navigation system error process model 200 which receives inputs from a terrain referenced navigation measurement model 201 and a global positioning system measurement model 202. The terrain reference navigation measurement model 201 receives inputs from a radio altimeter, and a digital terrain elevation database 204. An inertial navigation system 206 receives data input from a baro-altitude measurement device 207. An output from the inertial navigation system is input into the Kalman filter, which corrects the output data of the inertial navigation system according to data measured from the radio altimeter 203, digital terrain elevation database 204, according to the terrain referenced navigation measurement, and system error process model, and feeds back a corrected navigation system data to be combined with the original data, which forms a corrected inertial navigation system output.

Other navigation sensors, such as the prior art satellite based global positioning system (GPS) may be used to update the measurement processes in the terrain referenced navigation Kalman filter.

However, many vehicle platforms do not carry an inertial navigation system, and therefore cannot use the TRN system as shown in FIG. 2, without installation of an inertial navigation system, with its associated cost.

### SUMMARY OF THE INVENTION

One object according to the specific embodiments of the present invention is to provide a terrain referenced navigation system, which does not rely on an inertial navigation system. Specific implementations according to the present invention may allow terrain referencing of GPS navigation outputs directly without the need for an inertial navigation system. This is achieved by basing a terrain reference navigation Kalman filter on an error model of GPS.

A second object according to the specific embodiments to the present invention is to provide a terrain referenced navigation system which can be integrated with other digital terrain systems on a vehicle platform. Such other systems may include for example precision ground collision and avoidance systems, terrain following systems, obstacle warning systems, and passive and look aside ranging systems.

In a best mode implementation, position, velocity and time data is input from a GPS receiver. This data is used to determine a vehicles current position and height in geographic axes. Using specifically constructed Kalman filter states, the geographic position and height is referenced to a digital terrain elevation data, and an estimated ground clearance at the vehicles position is determined. The ground clearance is differenced with the radar altimeter output, and a residual is processed by the Kalman filter to determine a new state vector, including estimates of the current errors in the GPS data. Outputs can be configured to be either referenced to navigation axis, or to a digital terrain database for use by other digital terrain system functions.

According to a first aspect of the present invention there is provided a global positioning system based terrain referenced navigation system comprising:

at least one data processor (501);

a memory device (502), configured to communicate with said processor for storage of data;

a global positioning system interface (503) capable of receiving 3-dimensional position, velocity and time data from a global positioning system;

an altimeter interface (504) capable of receiving altitude data from an altimeter device (303);

a digital terrain elevation data interface (505) capable of receiving digital terrain elevation data.

According to a second aspect of the present invention there is provided a method of terrain referencing of navigation data, said navigation data produced by a global positioning system, said method comprising the steps of:

inputting global positioning system (700) position, velocity and time data from a global positioning receiver system;

determining (701) a current geographical position data and height data of a vehicle in geographic axes from said data input from said global positioning system;

referencing (702) said determined geographical position data and height data to a digital terrain elevation data using Kalman filter states;

determining (703) an estimated ground clearance of said vehicle at a current position of said vehicle;

obtaining (704) a difference between said estimated ground clearance of said vehicle at said current position, and an altimeter data received from an altimeter data source; and

processing (705) said difference by a Kalman filter to determine an estimate of current errors in said global positioning system data.

According to a third aspect of the present invention there is provided a method of producing terrain referenced navigation data from data inputs including:

digital terrain elevation data;

altitude data; and

position, velocity and time data,

said method comprising the processes of:

storing said digital terrain elevation data;

applying a terrain referenced navigation measurement model to said digital terrain elevation data;

applying a terrain referenced navigation measurement model to said altitude data;

applying a global positioning system error processing model to an output of said terrain referenced navigation measurement model and said position, velocity and time data;

generating an error corrected output of said global positioning system position, velocity and time data.

According to a fourth aspect of the present invention there is provided a method of error correcting an output of a global positioning system using an altitude data output of a radio altimeter, and terrain elevation data, said method comprising the processes of:

receiving a 3-dimensional position, velocity and time data from said global positioning system;

receiving said altitude data from said altimeter device;

receiving said terrain elevation data; and

applying a global positioning system error process model to said 3dimensional position, velocity and time data, wherein said error process model applies said altitude data and said terrain elevation data to said 3 dimensional position, velocity and time data to produce a terrain referenced position, velocity and time data output.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a helicopter platform fitted with a radio altimeter, flying over the earths surface receiving signals from a global positioning system satellite;

FIG. 2 illustrates schematically a prior art Kalman filter correction system for an inertial navigation system on receiving inputs from a radar altimeter digital terrain database and GPS;

FIG. 3 illustrates schematically a set of digital terrain system functions receiving inputs from a terrain navigation system according to a specific implementation of the present invention;

FIG. 4 illustrates schematically a vehicle cockpit interior, comprising a display warning monitor, obstacle warning instrumentation, and terrain following instrumentation, providing pilot readable instrumentation for monitoring information available from the specific implementations of the present invention;

FIG. 5 illustrates schematically a navigation system according to a second specific implementation of the present invention;

FIG. 6 illustrates schematically a system configuration implementation of the components of FIG. 5; and

FIG. 7 illustrates schematically overall process tips for the operation of the navigation system illustrated in FIGS. 3-6 herein;

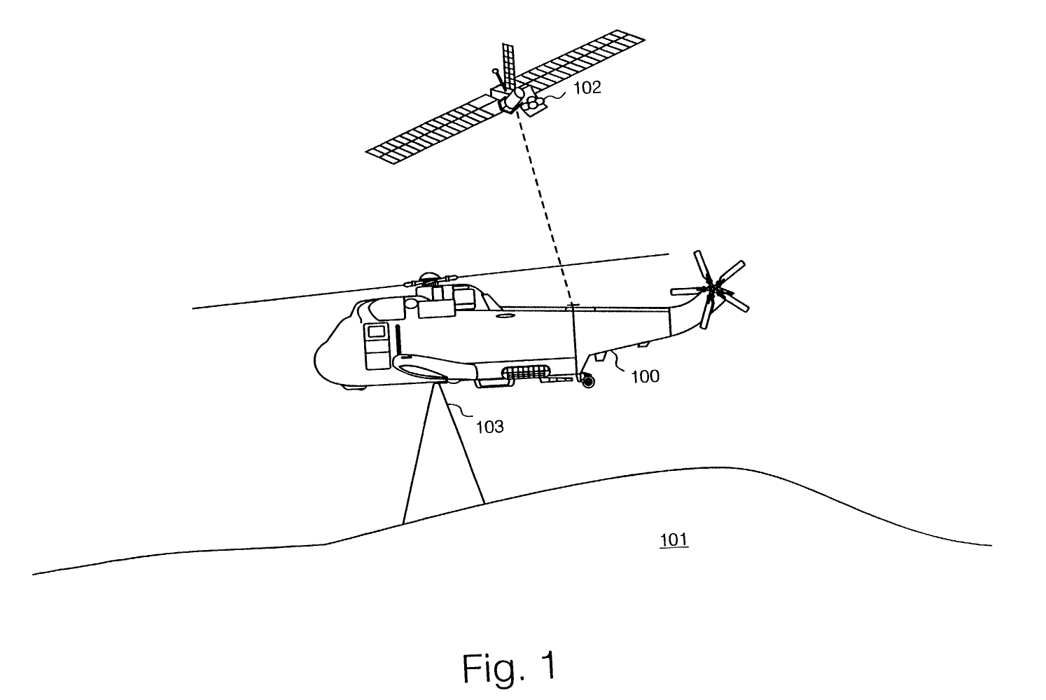

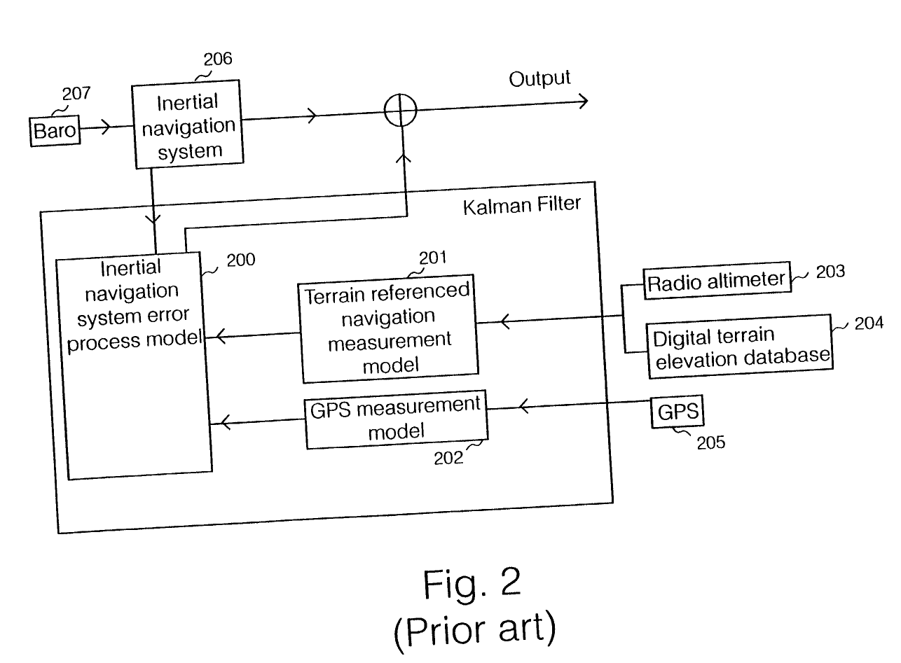

### DETAILED DESCRIPTION OF THE BEST MODE FOR CARRYING OUT THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

A best mode specific implementation according to the present invention allows terrain referencing of GPS navigation outputs directly, without the need for an inertial navigation system. This is achieved by basing a terrain referenced navigation system Kalman filter on an error model of a global positioning system.

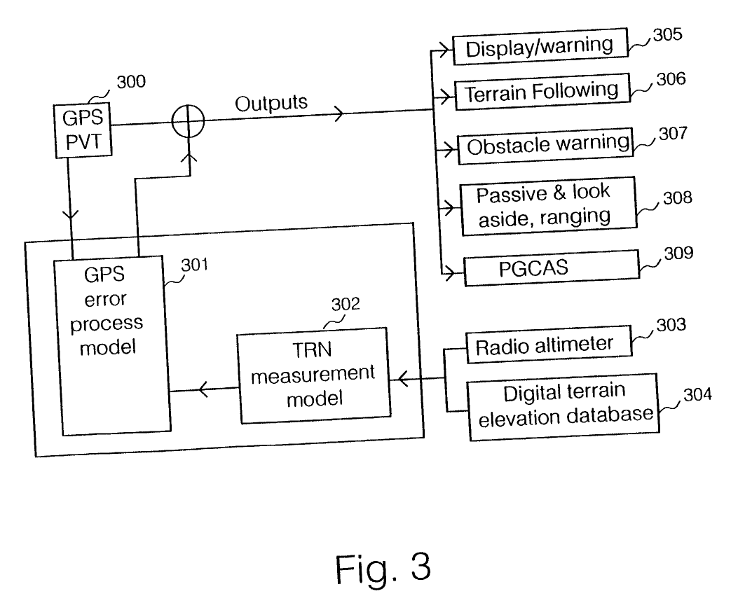

Referring to FIG. 3 herein, there is illustrated schematically components of a navigation system according to a specific implementation of the present invention. The navigation system comprises a global positioning system 300, outputting position, velocity and time data; a GPS error processing model 301 receiving the position, velocity and time data from the GPS system and outputting a GPS data error corrected with respect to terrain data; a terrain referenced navigation measurement model 302, outputting Kalman filter residuals into the GPS error process model; a radio altimeter 303, outputting altitude data into the TRN measurement model 302; and a digital terrain elevation database 304 outputting terrain elevation data which is fed into the TRN measurement model 302. An output from the system comprises the GPS data, combined with an error output from the GPS error process model, giving corrected GPS position, and velocity data with respect to the digital terrain deviation database, which can be used by other on board systems of the vehicle, including for example a display and warning system 305; a terrain following system 306; an obstacle warning system 307; a passive and look aside ranging system 308; and a PGCAS system 309.

The apparatus of FIG. 3 can be retrospectively fitted to a vehicle already having a GPS system 300, and a radio altimeter 303. Additional components required to be fitted to a vehicle include a data processor and associated memory implementing the GPS error process model 301 and the TRN measurement model 302, together with a display and warning console 305 for providing information and optionally, warnings, to a pilot of the vehicle.

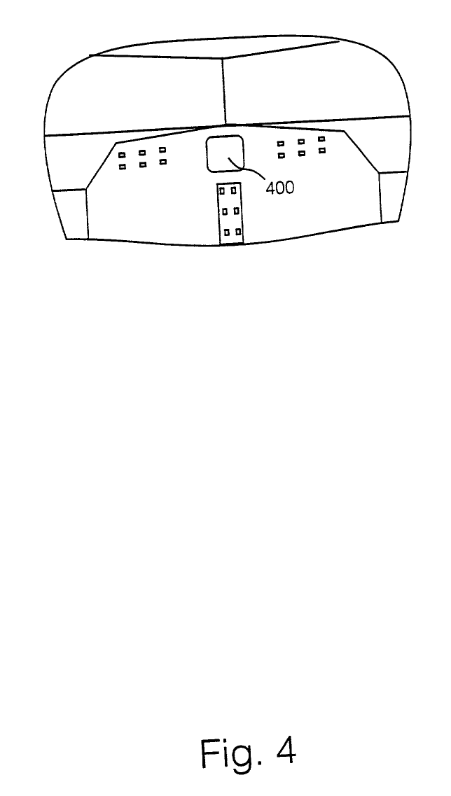

Referring to FIG. 4 herein, there is illustrated schematically a view of a cockpit of a vehicle fitted with the navigation system of FIG. 3 herein. The vehicle cockpit comprises a display device 400 providing the functions of obstacle warning, and other information and warnings to a pilot of the vehicle.

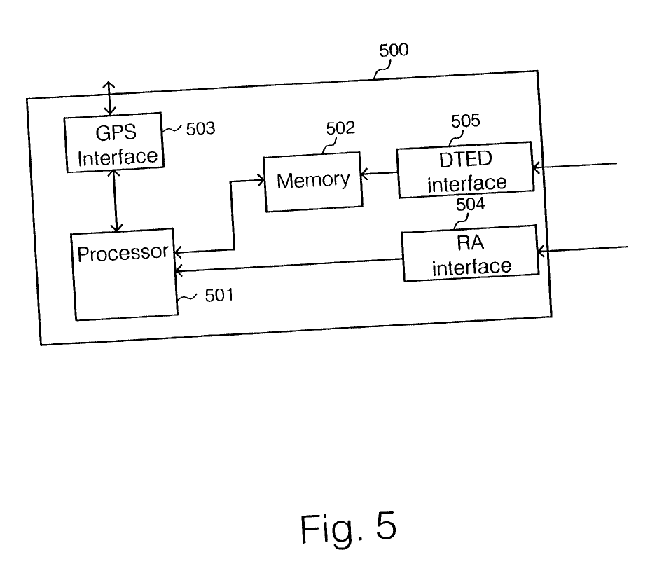

Referring to FIG. 5 herein there is illustrated schematically hardware components required to implement the system of FIGS. 3 and 4. Hardware requirements include a processor 501 having an associated memory area 502; a GPS interface 503; and a radio altimeter interface and digital terrain elevation data interface 504. The GPS interface 503, and radio altimeter and digital terrain elevation data interface 504 may be implemented by conventional means such as an application specific integrated circuit (ASIC), or by a processor 501 operating according to a computer program written to provide the interface functions, for example in a conventional programming language such as C or C++.

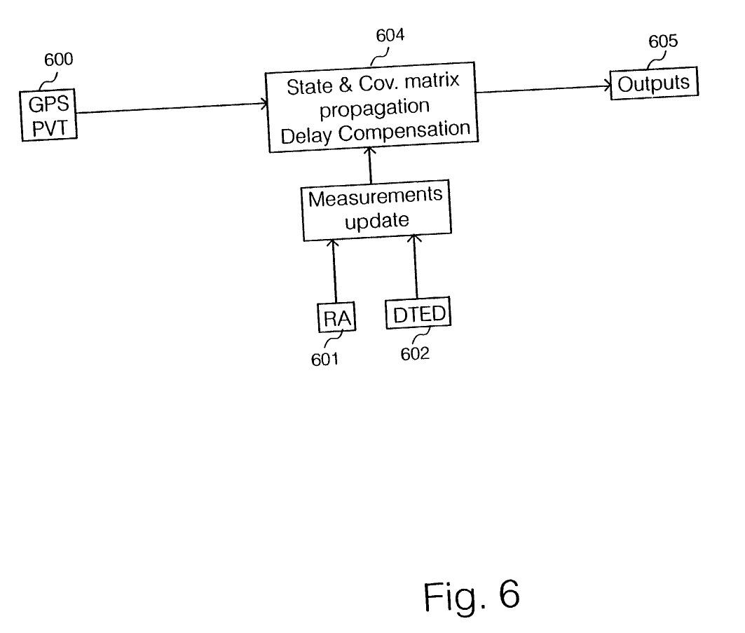

Referring to FIG. 6 herein, there is illustrated schematically a system configuration implemented by the hardware of FIG. 5. A full GPS position, velocity and time data is available for input, from a global positioning system 600. The time output is representative of the GPS data “time of validity” output. The difference between the GPS time of validity data, and a second time operated by the system (“system time”) is assumed to represent a GPS data delay. Altitude data is read in from the radar altimeter 600. GPS velocity data is used in terms of navigation, to synchronize the inputs of a GPS position in three dimensions, and the radar altimeter data.

At the core of the system is the introduction of GPS position error state data and GPS height error state data which accompanies a map error state. The form of the GPS error data varies according to whether the GPS receiver is operating in precise positioning service (PPS) mode, or standard positioning service (SPS) mode. A digital terrain elevation data (DTED) datum is provided by a digital terrain elevation database 602. The digital terrain elevation data has a vertical reference which is with respect to local mean sea level. The DTED also has varying horizontal and vertical ‘offsets’ with respect to local geographic axes which result from source data registration errors.

The GPS position, velocity and time data is input into the Kalman filter covariance matrix propagation algorithm 604, which compares and references the GPS data to the altitude data from the radar altimeter 601 and the digital terrain elevation data output from DTED 602, to provide corrected GPS output data 605. All data processing occurs in real time, as the vehicle moves across a terrain, to give error corrected GPS data.

State vector and co-variance matrix initialisation, propagation and measurement update equations are implemented to process the input GPS, position velocity and time data, by means of an algorithm implemented as a computer program written in a conventional language, for example C, C ++, stored in memory 504 and implemented by processor 501.

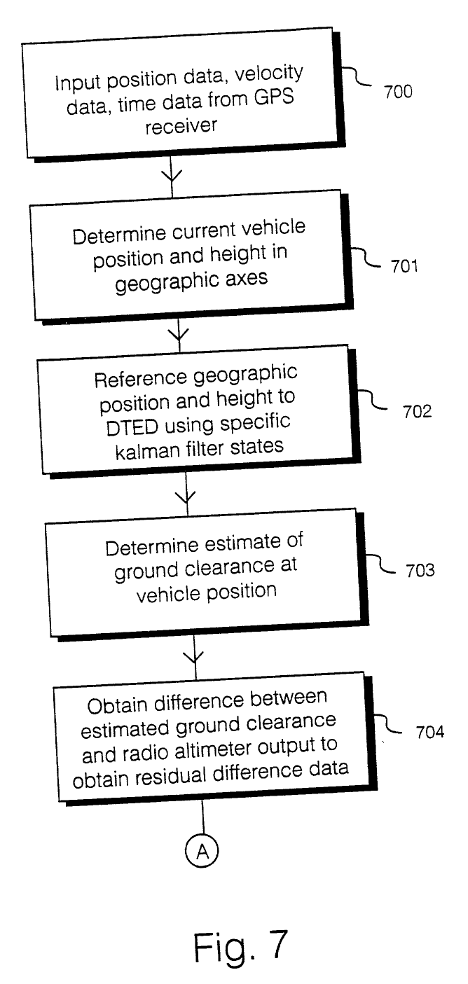

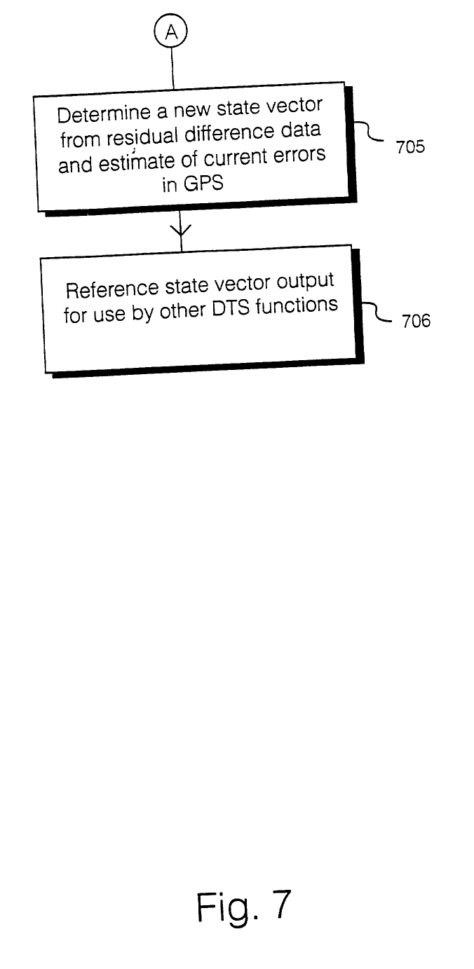

Referring to FIG. 7 herein, there is illustrated schematically overall process steps for operation of the navigation system illustrated in FIGS. 3-6 herein. The process of FIG. 7 operates continuously on collected data in real time, to produce a real time output in the form of a reference state vector, which can be used in other digital terrain systems on board the vehicle platform. In process 700, input data of position data, velocity data, and time data are continuously received from a GPS receiver on board the vehicle. In process 701, a current vehicle position and height are determined in geographic axis, from the stream of position data, velocity data, and time data. In process 702, the determined geographic position and height are referenced to a digital terrain elevation data base, using specifically constructive Kalman filter states. In process 703, as a result of process 702, an estimate of ground clearance at the vehicle position is determined. In process 704, the ground clearance output of process 703 is difference with an output from a radar altimeter, and a residual difference data is obtained. In process 705, the residual difference output is processed by a Kalman filter to determine a new state vector which includes estimates of current errors in the GPS data system. In process 706, the referenced state vector output can be used by other digital terrain systems on board the vehicle.

The GPS based terrain reference navigation system disclosed herein may be used as a stand alone navigation system, but also may be used in a role to support other digital terrain system based functions such as terrain following and ground proximity warning (GPW). The systems according to the best mode may have an ability to match an inherent horizontal channel accuracy of GPS, particularly in precise positioning service (PPS) with the good height accuracy of terrain referenced navigation. Consequently, the implementations disclosed herein may meet the fundamental requirements for driving other DTS capabilities, needing accurate referencing, particularly in the vertical channel with the respect of the DTED database.

1. A global positioning system based terrain referenced navigation system comprising:
at least one data processor;
a memory device, configured to communicate with said processor for storage of data;
a global positioning system interface capable of receiving 3-dimensional position, velocity and time data from a global positioning system;
an altimeter interface capable of receiving altitude data from an altimeter device;
a digital terrain elevation data interface capable of receiving digital terrain elevation data.

2. The system as claimed in claim 1, wherein said memory device and data processor are configured to:
store digital terrain elevation data;
apply a terrain referenced navigation measurement model to said digital terrain elevation data;
apply said terrain referenced navigation measurement model to said altitude data;
input a result of said terrain referenced navigation measurement model on said altitude and digital terrain elevation data into a global positioning system error process model;
input said global positioning system position, velocity and time data into said global positioning system error process model; and
produce an error processed output of said global positioning system, position, velocity and time data and said terrain referenced navigation measurement model data.

3. A method of terrain referencing of navigation data, said navigation data produced by a global positioning system, said method comprising the steps of:
inputting global positioning system position, velocity and time data from a global positioning receiver system;
determining a current geographical position data and height data of a vehicle in geographic axes from said data input from said global positioning system;
referencing said determined geographical position data and height data to a digital terrain elevation data using Kalman filter states;
determining an estimated ground clearance of said vehicle at a current position of said vehicle;
obtaining a difference between said estimated ground clearance of said vehicle at said current position, and an altimeter data received from an altimeter data source; and
processing said difference by a Kalman filter to determine an estimate of current errors in said global positioning system data.

4. The method as claimed in claim 3, wherein said estimate of current errors in said global positioning system data are determined as a vector data.

5. A method of producing terrain referenced navigation data from data inputs including:
digital terrain elevation data;
altitude data; and
position, velocity and time data,
said method comprising the processes of:
storing said digital terrain elevation data;
applying a terrain referenced navigation measurement model to said digital terrain elevation data;
applying a terrain referenced navigation measurement model to said altitude data;
applying a global positioning system error processing model to an output of said terrain referenced navigation measurement model and said position, velocity and time data; and
generating an error corrected output of said position, velocity and time data.

6. A method of error correcting an output of a global positioning system using attitude data output of a radio altimeter, and terrain elevation data, said method comprising the processes of:
receiving a 3-dimensional position, velocity and time data from said global positioning system;
receiving said altitude data from said altimeter device;
receiving said terrain elevation data; and
applying a global positioning system error process model to said 3-dimensional position, velocity and time data, wherein said error process model applies said altitude data and said terrain elevation data to said 3-dimensional position, velocity and time data to produce a terrain referenced position, velocity and time data output.

7. The method as claimed in claim 6, comprising the processes of;
applying a terrain referenced navigation measurement model to said terrain elevation data;
applying said terrain reference navigation measurement model to said altitude data;
inputting a result of said terrain referenced navigation measurement model on said altitude and terrain elevation data into said global positioning system error process model;
inputting said 3-dimensional position, velocity and time data into said global positioning system error process model; and
producing a global positioning system error processed output of said global positioning system position, velocity and time data and said terrain referenced navigation measurement model.
